(19) United States
(12) Patent Application Publication
(10) Pub. No.: US 2017/0210063 A1
(43) Pub. Date: Jul. 27, 2017

(54) FINISHING SYSTEM FOR 3D PRINTED COMPONENTS

(71) Applicant: 3M INNOVATIVE PROPERTIES COMPANY, St. Paul, MN (US)

(72) Inventors: Christine M. ANDRES, Washington, DC (US); William J. BRYAN, San Rafael, CA (US); John C. SCHULTZ, Afton, MN (US); Michael R. KESTI, Minneapolis, MN (US); Richard C. ALLEN, Lilydale, MN (US)

(73) Assignee: 3M INNOVATIVE PROPERTIES COMPANY, St. Paul, MN (US)

(21) Appl. No.: 15/500,550

(22) PCT Filed: Aug. 3, 2015
(86) PCT No.: PCT/US15/43361

§ 371 Date: Jan. 31, 2017

Related U.S. Application Data
(60) Provisional application No. 62/032,840, filed on Aug. 4, 2014.
(60) Provisional application No. 62/049,126, filed on Sep. 11, 2014.

(51) Int. Cl. B29C 65/00; B33Y 40/00; B29C 63/02; B29C 67/00; B29C 65/48; B29C 37/00

(52) U.S. Cl. CPC B29C 66/344; B29C 65/4825; B29C 66/474; B29C 37/0025; B29C 63/02; B29C 67/0055; B33Y 40/00; B29K 2101/12

(57) ABSTRACT

Finishing system for a 3D printed object involves applying a film to an outer surface of the object in order to hide surface artifacts associated with the 3D printing process that created the object.

### BACKGROUND

Fused deposition modeling (FDM) (also called fused filament fabrication) is an 3D printing technology commonly used for modeling, prototyping, and production applications. FDM works on an “additive” principle by laying down material in layers; a plastic filament or metal wire is unwound from a coil and supplies material to produce a part.

FDM begins with a software process which processes a 3D representation of an object, mathematically slicing and orienting the model for the build process. If required, support structures may be generated and added to the model. The model or part is then produced with a 3D printing machine, which extrudes small beads of thermoplastic material to form layers, the material typically hardens immediately after extrusion from the nozzle. The 3D printer may dispense multiple materials to achieve different goals: for example, one material may be used to build up the model and another for a support structure.

Within the 3D printer, a plastic filament is typically used to provide the raw material that will be built up. The plastic filament is unwound from a coil and supplies material to an extrusion nozzle which can control the egress of material. The nozzle is heated to melt the material. Thermoplastics are heated past their melting temperature and are then deposited by the extrusion head.

The nozzle associated with such a 3D printer can typically be moved in both horizontal and vertical directions by a numerically controlled mechanism. The nozzle follows a tool-path controlled by a computer-aided manufacturing (CAM) software package, and the part is built from the bottom up, one layer at a time. Stepper motors or servo motors are typically employed to move the extrusion head. This process may result in a “layered” surface, where individual steps associated with each layer progress in an overall direction. Such a surface may not be suitable for some application areas where a more sophisticated finish is desired.

Myriad materials are available to use in such a 3D printing system, such as acrylonitrile butadiene styrene (ABS), polylactic acid (PLA), polycarbonate, polyamides, polystyrene, lignin, among many others, with different trade-offs between strength and temperature properties.

### SUMMARY

A method of modifying an external surface of a 3D printed part, generally to give the external surface a more finished appearance. Some 3D printed parts have step-related surface characteristics, which are artifacts of the 3D printing process used to create the parts. Such artifacts may not be appropriate for the end use of the part, particularly where the step-related artifacts are not desirable. A suitably thick adhesive backed film may be applied to the surface to render the step-related artifacts substantially undetectable.

In one embodiment, a method of modifying a surface of a three dimension printed object made by sequential 3D layer buildup and having at least a first surface is described, the method comprising applying a stretchable adhesive-backed film to the first surface of a three dimension printed object having step-type printing artifacts, wherein the adhesive backed film comprises a substrate having a first major surface and a second major surface, and wherein the second major surface has a pressure sensitive adhesive layer disposed thereon;

wherein applying comprises, in one embodiment, applying heat to an area of the adhesive-backed film, and pressing the area onto an area of the first surface; and wherein the step-type printing artifacts associated with the area of the first surface are substantially undetectable after the applying step. The process may also be carried out without heat, wherein the adhesive-backed film is pressed into intimate contact with the 3D printed surface.

In another embodiment, a surface modified 3D printed object is described, the object comprising a three dimensional printed part having a first surface with step-type printing artifacts; a stretchable adhesive-backed film comprising a substrate having a first major surface and a second major surface, the second major surface interfacing with an adhesive layer; and wherein the adhesive layer couples the substrate to the first surface, and the step-type printing artifacts associated with an area of the first surface are substantially undetectable.

These and other embodiments are described further herein.

BRIEF SUMMARY OF DRAWINGS

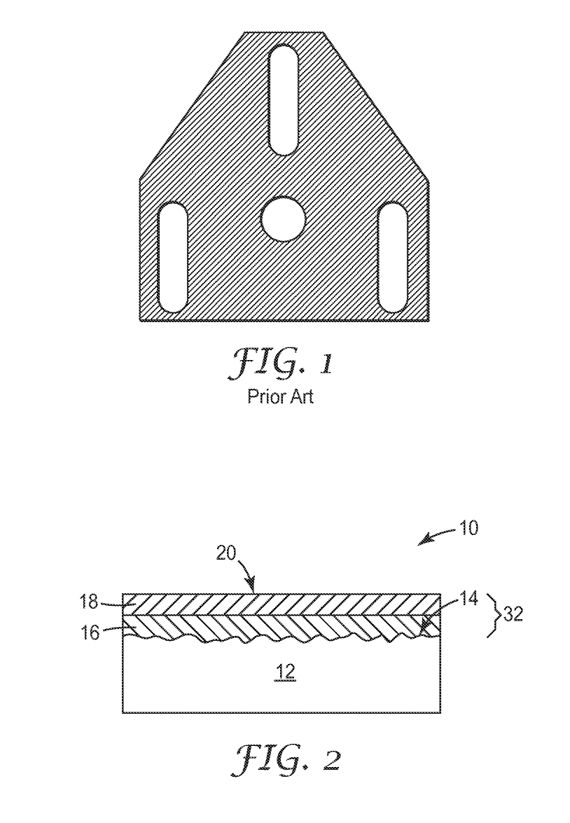

FIG. 1 is a prior art rendering of a printed part.

FIG. 2 is a drawing of the stack-up associated with a wrapped, 3D printed part.

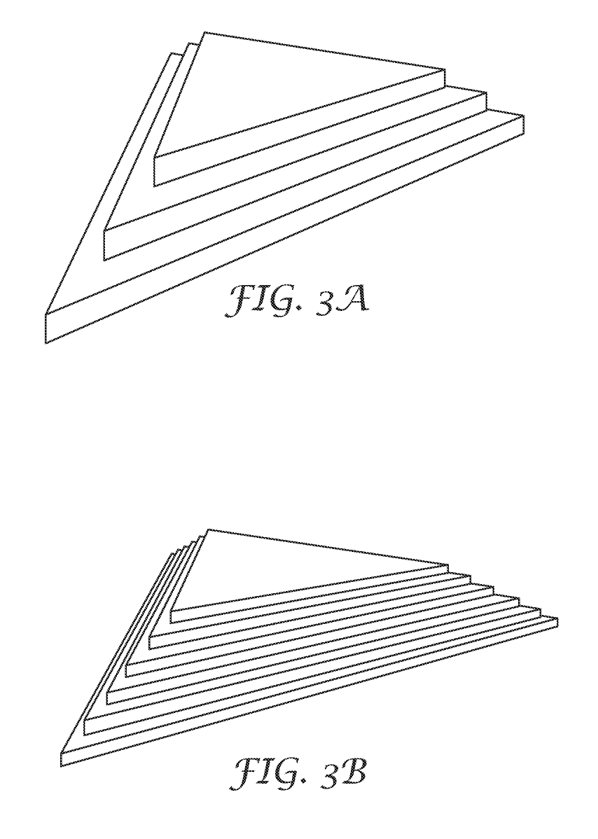

FIG. 3A is a drawing of a 3D printed part showing steps, or artifacts, associated with the 3D printing process.

FIG. 3B is a drawing of a 3D printed part showing steps, or artifacts, associated with the 3D printing process.

FIG. 4 is a drawing of a 3D printed part and a wrap.

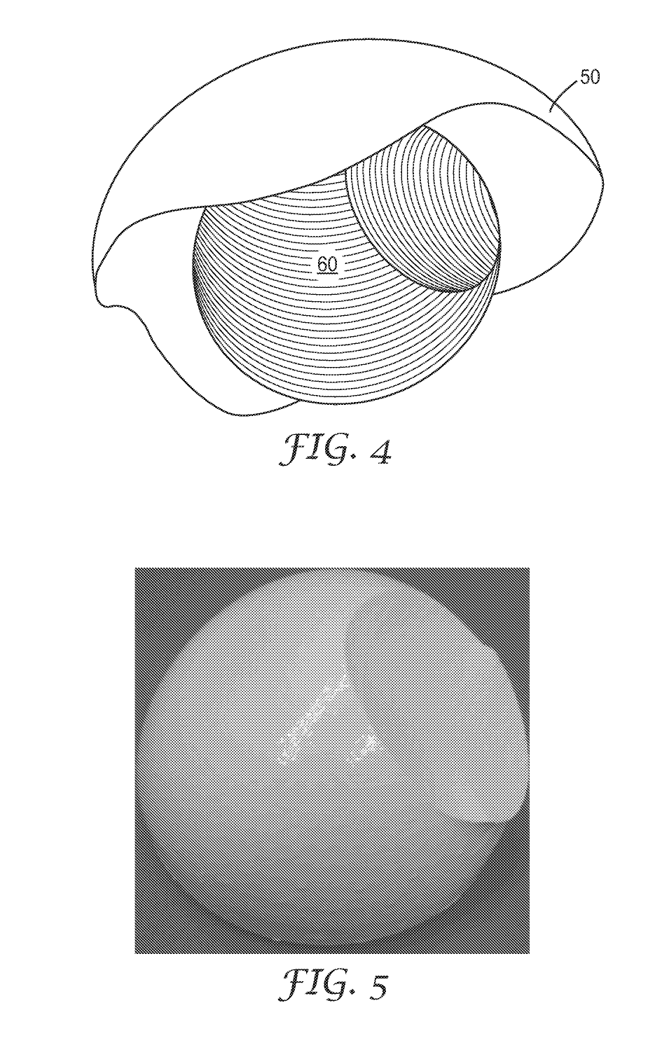

FIG. 5 is a drawing of a finished, wrapped 3D part.

### DETAILED DESCRIPTION

A common type of 3D printing involves extruded thermoplastic materials, for example ABS, polycarbonate, nylon, polypropylene, polyetherimide and the like. To “print” a 3D object, these materials are deposited in an XY plane which is stepped in the Z plane to create the desired 3D shape. Each step in Z thus leaves an irregular surface with the size of the irregularity a tradeoff between the precision of the part, if a small Z step is used, and faster fabrication speed, if a large Z step is used. Objects which include overhanging or hollow regions can incorporate permanent or temporary internal, for example wax model material, structures or external support structures if the basic object shape is not self-supporting.

The apparatus for carrying out 3D printing typically moves the printheads over the print surface in raster fashion along orthogonal X and Y axes. This process results in a “layered” surface because of the finite Z step with trade-offs between quality and speed. Finite steps in Z are particularly apparent on regions of the fabricated surfaces with relatively shallow slope in the Z step direction. For example if the slope of the parts is such that the next layer deposition is at a planer offset of more than 2 or 3 times layer thickness, a rough finished surface will result, the finished surface having step-type printing artifacts. Note that the part may be fabricated on its side so that the height of the part may not be the Z dimension during the 3D printing process.

These and other issues with 3D printing with finite resolution in X, Y and Z result in parts that have a rough, jagged, “pixilated” surface, even at times being porous, which is often not visually or aesthetically pleasing. Further, such surface finishes may be functionally limiting if smooth or impermeable surface properties are a needed attribute of the 3D printed part. For example, small gaps and crevices on a surface of 3D printed devices make it difficult to sterilize the surface and prevent bacteria from getting trapped.

FIG. 1, a drawing of a prior art 3D printed part, shows step-type finish artifacts that may be associated with some types of 3D printing. Such a finish may be unsuitable for some application areas where a more sophisticated or functional finish is desired. Techniques do exist for smoothing the surface 3D printed artifacts, for example by mechanical (e.g., grinding, polishing), chemical (e.g., heated acetone vapor), or thermal (e.g., localized IR or other heating) means, or through the use of thickly applied coatings. The efficacy of such techniques is highly dependent on the required surface characteristics of the resulting surface, in view of considerations related to time, cost, durability, etc.. Such techniques may serve only to smooth the part, which may then require additional steps to accommodate graphics, controlled texture, or surface functionality. In some embodiments, it may be desirable to preliminarily finish the surface before a film is applied to deliver optimal cosmetic and functional characteristics.

FIG. 2 is a drawing showing a side profile view of wrapped 3D printed part 10. The wrapped printed part 10 includes a modified surface 20, which may in some embodiments address certain above-mentioned issues inherent to some types of 3D printing. 3D printed part 12 is shown with unfinished surface 14. 3D printed part may result from any type of 3D printed processes, for example, stereolithography, selective laser singering/melting, fused deposition modeling, inkjet deposition of liquid binder on powder, laminated object manufacturing, material jetting, and the like. 3D printed part 12 may comprise any workable formulation. Some of the most often used formulations for additive manufacturing include acrylonitile butadiene styrene, polylactic acid, polyvinyl alcohol, polycarbonate, and polylactic acid. Unfinished surface 14 is the undulating, sometimes stepped-looking finish associated with a printed part. The size of such undulations is a function of the slopes of the object and the step size of the 3D printer. Typical step sizes of 0.1 mm are often seen, but much thinner slices, down to 0.010 mm or thinner are or will be possible for finely detailed parts or portions of parts. Similarly, thicker layers up to 0.5 mm or thicker are or will be possible for fast build of parts and/or regions that do not need fine detail in the depth direction. FIG. 3A and 3B show differing step sizes for the same basic part. In some embodiments, there may be additional film layers applied to the unfinished surface as well, such that unfinished surface is itself a surface of a film layer. The steps here are a type of 3D printing artifact; other artifacts, which manifest themselves as surface irregularities, are possible depending on the printing process used. Similarly, the unfinished surface 14 may in some embodiments be treated with various pretreatments, to prepare the unfinished surface for additional adhesive layer 16 and finishing substrate 18. For example, the pretreatments may seal, polish, or fill the unfinished surface 14, making the surface more suitable for the application of further substrates, as discussed below.

Pretreatments may include for example the application of a solvent, either in liquid or vapor phase, to the surface of the 3D printed part. Such solvent may lightly solubilize the surface to allow for some extent of surface finishing. In the case of ABS, easily accessible solvents such as acetone, esters, keytones or ethylene dicholoride could be used. Application of the solvent could be done by brushing the part with solvent by hand, briefly submerging the part, or processing the part in a solvent delivery system such as that marketed under the name “Finishing Touch Station” from Stratasys of Edina, Minn.

Alternatively, the pretreatment could comprise abrading the surface of the part to provide some smoothing during pretreatment. Traditional sandpaper and/or known abrasive tools could be used to pretreat the surface by hand, or a liquid phase bead blasting approach could be used. Alternatively, more automated techniques such as vibratory or centrifugal tumbling with plastic, ceramic, synthetic, or natural media could be used.

Finally, additional liquid phase materials could be delivered to the surface by various means of material delivery such as spray, dipping, painting or coating to prime and potentially smooth the surface for application of the discussed adhesive layer.

As mentioned, such pretreatment steps may or may not be necessary or desirable depending on application. They may or may not completely smooth artifacts associated with the 3D printing process. Such pretreatment steps may be incorporated in the overall production process of composite 3D printed parts (where more than one 3D printed part is incorporated into a final assembly), either pre-treating individual components individually before assembly, or pretreating the composite part after assembly, depending on application. Thus, as the term is used herein, unfinished surface 14 refers to the surface to which a further finishing substrate is to be applied, and such unfinished surface may have been pretreated in advance of such application.

Returning to FIG. 2, Adhesive layer 16 interfaces finishing substrate 18 and unfinished surface 14. Adhesive layer 16 may comprise a pressure sensitive or pressure activated adhesive (both referred to as PSAs), acrylate based materials, or thermoplastic adhesives based on polyester, polyurethane, ethylene, or acrylic acid based resins. For example 3M™ Bonding Films 406, 615, or 668 may comprise suitable adhesive layers. Air release features, for example air egress channels as for example described in U.S. Pat. No. 6,197,397 “Adhesives Having a Microreplicated Topography and Methods of Making and Using Same” (Sher et. al.) may be incorporated into some or all of the adhesive layers. Adhesive layer 16 may alternatively comprise adhesives such as epoxy adhesives which may be activated by temperature, time, radiation or other known methods of adhesive activation.

The thickness of the adhesive layer may be varied to accommodate and, in some embodiments, assist in hiding any surface irregularities associated with unfinished surface 14. The ideal thickness of the adhesives relates to the size of the undulations on the surface, the thickness and properties of the film applied, and the surface finish desired. For example, larger undulations with thinner films require thicker adhesive. As the surface features could be less than 0.01 mm or greater than 0.5 mm the thickness of a suitable adhesive could be between 0.5 mil or upwards of 8 mil. The thickness of the adhesive layer can be spatially controlled with for example a printing technology to account for the varied surfaces and slopes present across the single three dimensional part. For example, the adhesive thickness may be increased in areas of the finished part that are expected to have rough surfaces, while the thickness may be reduced where for areas of the finished part that are not expected to have rough surfaces. When control over thickness is of special concern, the addition of a scrim to the adhesive layer can be applied.

Finishing substrate 18 has finished surface 20 that becomes the new external surface of wrapped 3D printed part 10. Substrate 18 may be any suitable film, woven fabric or non-woven material. Suitable printable films include 3M™ IJ180-10 a 2 mil thick, printable, white film with or without structured adhesives that facilitate air egress. This film may be used by itself or with an additional overlaminate such as 3M™ 8528 or 3M™ Envision™ Gloss Wrap Overlaminate 8548G. Other suitable printable films include 3M™ 480Cv3 Envision™ print wrapfilm, a 2 mil white, printable, non-PVC film with a luster finish which may also be used with overlaminates such as 3M's 8458G film. Other suitable films which are typically patterned but may also be printed with eco-sol, UV, solvent, aqueous, latex and the like printing techniques are 3M™ Wrap Film Series 1080, the films of which are 4.5 mil thick and include adhesive, and 3M™ DI-NOC™ Architectural Finishes, which include for example the DI-NOC Whiteboard Film which is 8 mils thick including adhesive and able to hide or obscure more aggressive features or underlying undulations and provide a writable and erasable surface to the wrapped parts. Finishing substrate 18 may be a woven or non-woven fabric with or without a printed pattern on one or both surfaces. Printing on both surfaces (e.g., the top of finishing substrate 18 and the bottom of finishing substrate 18) may, depending on the color and thickness of the finishing substrate, enhance the contrast of printed features, providing for the potential to light the object from the interior since many 3D printer materials are translucent. A single sided print on fabric will provide a unique texture as well as visual appearance to the 3D printed part. Finishing substrate may be a single film, or it may be a composite film comprised of two or more films laminated together.

Depending on the particular application, other suitable films may be thinner than 2 mils, intermediate between 2 and 8 mils, or thicker than 8 mils (the selection largely depends on the amount of 3D print artifact hiding desired). Finishing substrate 18 may be a single film, or it may be a stack of films including overlaminates, with properties such as environmental stability, ink receptivity, anti-graffiti, hydrophobicity, hydrophilic, anti-microbial, electrically conductive and the like. In one preferred embodiment, finishing substrate 18 contracts and becomes more compliant in the presence of applied heat, as from a heat gun or gas torch, and then may be pressed into place either by hand or with application tools, such as rollers, squeegees, etc. One application technique that may be suitable is described in U.S. Pat. No. 8,608,897 “Method of Applying Adhesive Coated Film” (Steelman et. al.), which describes a process whereby a portion of a film is heated and then brought in to contact with a rough surface (the contents of which are incorporated herein by reference). The finishing substrate 18 may be opaque or clear. The finishing substrate 18 may be printed prior to application, so as to include graphics or wording, etc.. The film may be a compliant film, that is, a polymeric film that is soft and flexible as well as having sufficient inelastic deformation after being stretched so that once stretched, the film does not recover to its original length.

FIG. 4 shows an example application of a finishing substrate 50 to 3D printed part 60. The part has surface artifacts in the form of steps associated with the 3D printing process. Finishing substrate is applied to the surface of 3D printed part 60, with the applicator applying heat and stretching the substrate to conform to exterior surface of 3D printed part 60. FIG. 5 shows wrapped 3D printed part 60, which is shown with a new surface that has hidden artifacts of the 3D printing process. Additionally, the color of the surface is now the color of the finishing substrate, and a glossy sheen has been introduced. The step-type artifacts of the 3D printing process may be substantially undetectable to the human eye after application. Of course, the application methods herein may be used to hide or obscure other types of 3D printing artifacts other than step-related ones, and in some embodiments it may not be desirable to make the artifacts substantially undetectable.

Application methods can include the application of heat, stretching, and/or pressure to the part, the film and/or adhesive, etc. to enable proper film coverage and adhesive properties. Proper cleaning and drying of the part may be required before film application. Heat and pressure can be applied through traditional or dual vacuum thermoforming techniques, using vacuum bags, ovens, heat guns, and roller, foam or brush based tools. Detergent, water or commercial application liquid may be employed to position the film on the surface of the part. In some cases the film may have a positionability feature that is later destroyed through application of heat or pressure. After forming, in some cases additional adjustments may be needed including further stretching and removal of additional film material, if not trimmed/shaped before application. In some cases the use of edge sealing may provide additional benefits. In some embodiments, the adhesive layer is brought into intimate contact with the unfinished surface 14, with or without heat. Intimate contact means the adhesive layer, after contact, substantially occupies an area associated with the artifacts, such that the finishing substrate rides above the adhesive layer and the artifacts are effectively obscured by the adhesive layer and the finishing substrate.

For example, 3M™ IJ180-10 film was loaded into a thermoforming tool where it was heated for 5 seconds above a chamber holding a clean and dry 3D printed part. With the adhesive layer facing the part, the part was introduced from below while negative pressure was maintained. In some cases the part was placed on a support to allow the film to wrap around the bottom edge of the part for a more complete wrap. After the adhesion, vacuum was removed, excess film was removed and a heat gun with a brush and roller could be used to make finishing touches to the part wrapping as necessary.

The process temperature, especially in the case of thermobonding and setting adhesives must be high enough for the adhesive to flow and or react as designed into the adhesive, yet low enough that the film is not destroyed. The amount of time the finishing substrate film needs to be held onto the part is determined by the properties of the adhesive of choice. For longer curing times it may be appropriate to apply pressure to the conformed film with the use of a vacuum bag and maintain the necessary temperature in an oven. Within even a single film/adhesive combination, the bonding strength is varied by optimization of the temperature/pressure combination.

Beyond modifying the aesthetic and tactile properties of a 3D printed part through the application of color or printed graphics, the application of a film to the surface of the 3D printed parts provides the opportunity to introduce additional functionality to the surface, based on the choice of film(s) and adhesive applied. For example specific additives or textures may be introduced to the surface of the 3D printed part, via the finishing substrate, to provide for example anti-microbial, anti-odor, enhanced comfort, controlled electrical (e.g., electric conductivity) or thermal conductive properties, wear/abrasion resistance, abrasion, optically/UV active or blocking, dirt repellency, etc.. For example, a fluoropolymer layer that provides non-stick or low friction properties, or increased thermal, chemical, or corrosion resistance, could be part of the finishing substrate. The functional surface may also comprise a light manipulation surface, for example, films that highly reflect (for example mirror or chrome film) or polarize light, or surfaces having a narrow reflection band, or fluorescent or phosphorescent films (absorb one spectrum of light, and reflect a different spectrum).

Together, adhesive layer 14 and finishing substrate 18 comprise wrap 22, which is an adhesive-backed film-based substrate. The combination of characteristics associated with these two layers may be optimized for particular applications. For example, thicker films and/or thicker adhesive layers will tend to provide a smoother surface. Thinner films with a relatively thick adhesive layer will hide some features while retaining some relevant detail.

The optimal film and adhesive thicknesses and the ratio between the two will be a function of the print resolution, design feature sizes process conditions and 3D printing flaws and step heights to obscure/hide. For example 3M™ IJ180cv3 2 mil film has an adhesive layer roughly 1 mil thick. This combination of a thin film with a relatively thin, compliant layer of adhesive is capable of hiding/obscuring some features, particularly if the film is printed by simply vacuum forming around the object. The film can be more closely conformed to the surface depending on any post lamination processing such as pressing the film into the part with a conformal, e.g. sponge-like, roller as a post vacuum lamination step with relatively little step hiding capability. Alternatively 3M™ DI-NOC™ film with an 8 mil film thickness and a 2 mil adhesive coating is much less conformal and hides/obscures surface features even if pressed onto the surface. Increasing the adhesive thickness for this type of film, for example by using two layers of adhesive, hides or obscures more 3D printing artifacts such as print errors or step sizes. As such, the optimal film and adhesive thickness is best determined experimentally for a set of printing conditions, printing resolution and final surface requirements. Thin, highly compliant films with thin adhesive layers will more faithfully reproduce the smallest unfinished features of the print, and may have more limited utility in wrapping a 3D printed part and obscuring detail of unfinished surface 14.

The film may be printed such that the print, when distorted by any of the application processes discussed above (for example, stretching and heating during application), maps onto the final structure so that a high quality printed surface results. Methods to distort a print graphic or image to accurately wrap around a non-flat object are known in the art. Adobe™ Photoshop™ has similar or superior tools as does ImageMagick™, Coreldraw™, Adobe™ Illustrator™ and others.

### Registration

In many cases a regular, irregular, or no pattern (that is, the absence of a discernible pattern) on the wrapping film is appropriate. However in cases in which the wrapped object must be aligned to the preferably pre-distorted film pattern (for example, a printed graphic on finishing substrate 18 has features that are intended to align with features of the 3D printed part). In such cases, a printed graphic may be printed onto finishing surface 20 of finishing substrate 18 (or a lower layer of if an overlaminate is intended to comprise finished surface 20) with a low-volume, easily customizable printing technology such as ink jet (often appropriate for low volume jobs). High volume jobs are often more appropriately handled using printing technology such as screen printing, dye-sublimiation, gravure, lithoprint, etc..

Fiducial marks may be printed onto the finishing substrate to align with features and/or other fiducial marks printed on the 3D printed part. Alternatively, the graphic or pattern printed on the finishing substrate 18 can be designed and printed so that discontinuities in the pattern serve the same function as the fiducial marks as noted previously.

Alternatively multiple sheets of printed material can be aligned to the part with the printed pattern isolated to a particular sheet or spanning multiple sheets or combinations of the two. Multiple sheets can then be aligned to particular features on the 3D printed part, possibly enabling the wrapping of more complex parts than could be accomplished with even the high conformability films noted previously.

1. A method of modifying a surface of a three dimension printed object made by sequential 3D layer buildup and having at least a first surface, the method comprising:
applying a stretchable adhesive-backed film to the first surface of a three dimension printed object having step-type printing artifacts, wherein the adhesive backed film comprises a substrate having a first major surface and a second major surface, and wherein the second major surface has an adhesive layer disposed thereon;
wherein applying comprises stretching the area of the adhesive-backed film, and pressing the area onto an area of the first surface;
and wherein the step-type printing artifacts associated with the area of the first surface are substantially undetectable after the applying step.

2. The method of claim 1, wherein applying further comprises brining the adhesive layer into intimate contact with the first surface.

3. The method of claim 1, further comprising:
pretreating the first surface before applying the adhesive-backed film.

4. The method of claim 1, wherein the adhesive layer comprises a pressure sensitive adhesive.

5. The method of claim 1, wherein applying further comprises applying heat to the area of the adhesive backed film, and wherein pressing the area comprises pressing the heated area of the adhesive backed film.

6. The method of claim 1, wherein the stretchable adhesive-backed film is a compliant film.

7. The method of claim 1, wherein the adhesive layer is a continuous adhesive layer.

8. The method of claim 1, wherein the substrate has a nominal thickness, and the adhesive layer has a nominal thickness, and wherein the nominal thickness of the substrate and the adhesive layer together is between 0.5 mils and 15 mils.

9. The method of claim 1, wherein the pressing that is done as part of the applying step is done with a squeegee.

10. The method of claim 1, wherein first major surface of the substrate comprises a functional surface.

11. The method of claim 10, wherein the functional surface comprises an abrasive surface.

12. The method of claim 10, wherein the functional surface comprises an electrically conductive surface.

13. The method of claim 10, wherein the functional surface comprises a light manipulation surface.

14. The method of claim 1, wherein the substrate comprise a composite film.

15. The method of claim 1, further comprising:
printing a graphic on the substrate.

16. The method of claim 15, further comprising:
printing fiducial marks upon the substrate, wherein the fiducial marks correspond with particular points on the three dimensional printed object.

17. The method of claim 16, wherein the three dimensional printed object includes printed indicia that correspond to at least some of the fiducial marks, and wherein applying further comprises aligning the fiducial marks to associated indicia.

18. The method of claim 15, wherein printing the graphic on the substrate comprises printing a distorted image on the substrate, the distorted image distorted such to appear not distorted after the applying step.

19. The method of claim 1, wherein the substrate comprises a thermoplastic film.

20. The method of claim 1, wherein the adhesive layer comprises a thermosettable adhesive, and wherein the applied heat is sufficient to initiate thermoset cure associated with the thermosettable adhesive.

21. A surface modified three dimensional printed object, comprising:
a three dimensional printed part having a first surface with step-type printing artifacts;
a stretchable adhesive-backed film comprising a substrate having a first major surface and a second major surface, the second major surface interfacing with an adhesive layer;
and wherein the adhesive layer couples the substrate to the first surface, and the step-type printing artifacts associated with an area of the first surface are substantially undetectable.

22. The surface modified three dimensional printed object of claim 21, wherein the substrate is a printed substrate.

23. The surface modified three dimensional printed object of claim 22, wherein the adhesive layer is in intimate contact with the first surface.

24. The surface modified three dimensional printed object of claim 21, wherein the first surface of the substrate is a functional surface.

25. The surface modified three dimensional printed object of claim 24, wherein the functional surface comprises a light manipulation surface.

26. The surface modified three dimensional printed object of claim 21, wherein the adhesive layer and the substrate have nominal thicknesses, and the combined nominal thickness of the adhesive layer and the substrate is between 0.5 mils and 10 mils.
